(19) United States
(12) Patent Application Publication
(10) Pub. No.: US 2014/0032415 A1
(43) Pub. Date: Jan. 30, 2014

(54) OFFLINE TRANSACTION PAYMENT SYSTEM, AND METHOD AND APPARATUS FOR THE SAME

(71) Applicants: Won Jun Lee, Seoul (KR); Se Hyun Kim, Seoul (KR); Dong Phil Lim, Seoul (KR); Hyeong Moon Kang, Seoul (KR); Young Deok Ko, Gyeonggi-do (KR)

(72) Inventors: Won Jun Lee, Seoul (KR); Se Hyun Kim, Seoul (KR); Dong Phil Lim, Seoul (KR); Hyeong Moon Kang, Seoul (KR); Young Deok Ko, Gyeonggi-do (KR)

(73) Assignee: SK PLANET CO., LTD., Seoul (KR)

(21) Appl. No.: 14/007,895

(22) PCT Filed: Oct. 23, 2012
(86) PCT No.: PCT/KR2012/008702

§ 371 Date: Oct. 18, 2013

(30) Foreign Application Priority Data
Mar. 12, 2012 (KR) 10-2012-0024932

(51) Int. Cl. G06Q 20/38

(52) U.S. Cl. CPC G06Q 20/385
USPC 705/44

(57) ABSTRACT

The present invention related to an offline transaction payment system and a method and apparatus for the same, which receives an electronic payment request from a terminal, transmits a request for execution of an electronic payment application to the terminal, receives an application ID from the electronic payment application executed in the terminal, performs member verification using the received application ID, transmits the member verification result to the electronic payment application, receives a one-time password from the electronic payment application, and mediates an electronic payment for a transaction that takes place offline using the one-time password.

### TECHNICAL FIELD

The present invention relates to an offline transaction payment system and a method and apparatus for the same and, more particularly, to an offline transaction payment system and a method and apparatus for the same, which uses a one-time password (OTP).

### BACKGROUND ART

The information disclosed in this section is only to provide background information about the embodiments and does not form the prior art.

Cash, credit card, or debit card is generally used to make a payment for a transaction that takes place offline. Recently, the use of credit cards has been recommended as a way to increase transparency in taxation of business transactions.

However, conventional transactions using credit cards have the inconvenience to have the credit card, the risk of loss of the credit card, the risk of exposure of credit card information and personal information, etc.

### DISCLOSURE

### Technical Problem

An object of the present invention is to provide an offline transaction payment system and a method and apparatus for the same, which makes it possible to conduct a transaction with a credit card without having to have the credit card.

Other objects of the present invention will be readily understood from the following description of embodiments.

### Technical Solution

A payment system in accordance with a preferred embodiment of the present invention comprises: a terminal which transmits an electronic payment request to an electronic payment service apparatus by reading information of an electronic tag, receives a request for execution of an electronic payment application from the electronic payment service apparatus, the electronic payment application being executed when personal identification information is input, makes a member verification request by transmitting an application ID to the electronic payment service apparatus, receives the member verification result from the electronic payment service apparatus, makes a payment authorization request by transmitting a one-time password to the electronic payment service apparatus, and receives the payment authorization result from the electronic payment service apparatus; and the electronic payment service apparatus which receives an electronic payment request from the terminal, transmits a request for execution of an electronic payment application to the terminal, receives an application ID from the electronic payment application executed in the terminal, performs member verification using the received application ID, transmits the member verification result to the electronic payment application, receives a one-time password from the electronic payment application, and mediates an electronic payment for a transaction that takes place offline using the one-time password.

Moreover, an electronic payment service apparatus in accordance with a preferred embodiment of the present invention comprises: an application execution unit which receives an electronic payment request from a terminal and transmits a request for execution of an electronic payment application to the terminal; a member verification unit which receives an application ID from the electronic payment application executed in the terminal, performs member verification using the received application ID, and transmits the member verification result to the electronic payment application; and an authorization request unit which receives a one-time password from the electronic payment application and mediates an electronic payment for a transaction that takes place offline using the one-time password.

Here, the member verification may be performed by determining whether the application ID received from the terminal and a phone number matching the application ID or a resident registration number is pre-stored.

Moreover, the authorization request unit may receive payment information and a one-time password from the terminal, transmit a payment authorization request including a virtual card number matching the terminal, the payment information, and the one-time password to a card company apparatus, and transmit the payment authorization result received from the card company apparatus to the terminal or an affiliated store terminal.

Furthermore, the virtual card number may be generated in response to a card number registered as a payment means during member subscription and may be information matching at least one of the phone number of the terminal, the application ID, and the resident registration number and managed.

In addition, the electronic payment service apparatus of the present invention may further comprise a member state identification unit which identifies a telecommunication company member state through an affiliated telecommunication company apparatus or an authentication apparatus in response to the reception of the one-time password.

A terminal comprising in accordance with a preferred embodiment of the present invention comprises: a tag reading unit which transmits an electronic payment request to an electronic payment service apparatus by reading information of an electronic tag and receives a request for execution of an electronic payment application from the electronic payment service apparatus; a member verification request unit which makes a member verification request by transmitting an application ID to the electronic payment service apparatus and receives the member verification result from the electronic payment service apparatus; a password generation unit which generates a one-time password; and a payment request unit which makes a payment authorization request by transmitting the one-time password to the electronic payment service apparatus and receives the payment authorization result from the electronic payment service apparatus.

Here, the electronic payment application may be executed when a user inputs personal identification information registered during subscription to an electronic payment service.

Moreover, the application ID may be unique information assigned to the electronic payment application during subscription to an electronic payment service.

Furthermore, the electronic payment application may generate the one-time password using an OTP authentication key received from a card company apparatus or the electronic payment service apparatus.

In addition, the OTP authentication key may be decrypted with the application ID.

A payment service providing method in accordance with a preferred embodiment of the present invention, which is performed by an electronic payment service apparatus, comprises the steps of: receiving an electronic payment request from a terminal; transmitting a request for execution of an electronic payment application from the terminal; receiving an application ID from the electronic payment application of the terminal; performing member verification using the received application ID and transmitting the member verification result to the electronic payment application; receiving a one-time password from the electronic payment application; and mediating an electronic payment for a transaction that takes place offline using the one-time password.

Moreover, a payment service providing method in accordance with a preferred embodiment of the present invention, which is performed by a terminal, comprises the steps of: transmitting an electronic payment request to an electronic payment service apparatus by reading information of an electronic tag; receiving a request for execution of an electronic payment application from the electronic payment service apparatus; making a member verification request by transmitting an application ID to the electronic payment service apparatus; receiving the member verification result from the electronic payment service apparatus; making a payment authorization request by transmitting a one-time password to the electronic payment service apparatus; and receiving the payment authorization result from the electronic payment service apparatus.

A payment service providing method in accordance with a preferred embodiment of the present invention comprises the steps of: transmitting, at a terminal, an electronic payment request to an electronic payment service apparatus by reading information of an electronic tag; transmitting, at the electronic payment service apparatus, a request for execution of an electronic payment application to the electronic payment service apparatus when receiving the electronic payment request; allowing the electronic payment application to be executed in the terminal; making, at the terminal, a member verification request by transmitting an application ID to the electronic payment service apparatus; performing, at the electronic payment service apparatus, member verification using the application ID and transmitting the member verification result to the terminal; making, at the terminal, a payment authorization request by transmitting a one-time password to the electronic payment service apparatus; and mediating, at the electronic payment service apparatus, an electronic payment for a transaction that takes place offline using the one-time password.

### Advantageous Effects

According to the present invention, it is possible to safely make a payment for a transaction that takes place offline without having a credit card by registering the credit card to be used for an offline payment to subscribe to an electronic payment service and making an online payment for the offline transaction using a one-time password.

Moreover, it is possible to prevent credit card information from leaking during the electronic payment by making the electronic payment using a virtual card number.

Furthermore, it is possible to significantly increase the security by making a payment only when a user using the electronic payment service is the same as the owner of a terminal by identifying the telecommunication company member state during the electronic payment.

### DESCRIPTION OF DRAWINGS

FIG. 1 is a block diagram schematically showing a payment system in accordance with a preferred embodiment of the present invention.

FIG. 2 is a block diagram schematically showing a payment system in accordance with another embodiment of the present invention.

FIG. 3 is a functional block diagram of a terminal of FIG. 1.

FIG. 4 is a functional block diagram of an electronic payment service apparatus of FIG. 1.

FIG. 5 is a functional block diagram of a card company apparatus of FIG. 1.

FIG. 6 is a flowchart showing an offline transaction payment method in accordance with a preferred embodiment of the present invention.

FIG. 7 is a flowchart showing an offline transaction payment method in accordance with another embodiment of the present invention.

### DESCRIPTION OF REFERENCE NUMERALS

100, 100a: terminal

110, 110a: electronic payment application

111: tag reading unit

112: member verification request unit

113: password generation unit

114: payment request unit

200, 200a: electronic payment service apparatus

210: application execution unit

220: member verification unit

230: member state identification unit

240: authorization request unit

300, 300a: telecommunication company apparatus

400, 400a: authentication apparatus

500, 500a: card company apparatus

600a: commodity information providing apparatus

700: communication network

### MODE FOR INVENTION

Hereinafter, preferred embodiments of the present invention will be described in detail with reference to the accompanying drawings. However, in the following description, detailed descriptions of well-known functions or configurations will be omitted. Moreover, the same components are denoted by the same reference numerals as far as possible throughout the drawings.

The terms or words used in the specification and claims which will be described below should not be narrowly construed as typical or denotative meanings. Rather, they should be construed as meanings or concepts matching the technical spirit of the present invention based on the principle that inventors may properly define the concepts of the terms to describe their inventions in the best way. Thus, it should be understood that the embodiments described in the specification and the configurations shown in the drawings figures are just preferred embodiments and there may be various equivalents and variations that replace these embodiments at the time of filing this application.

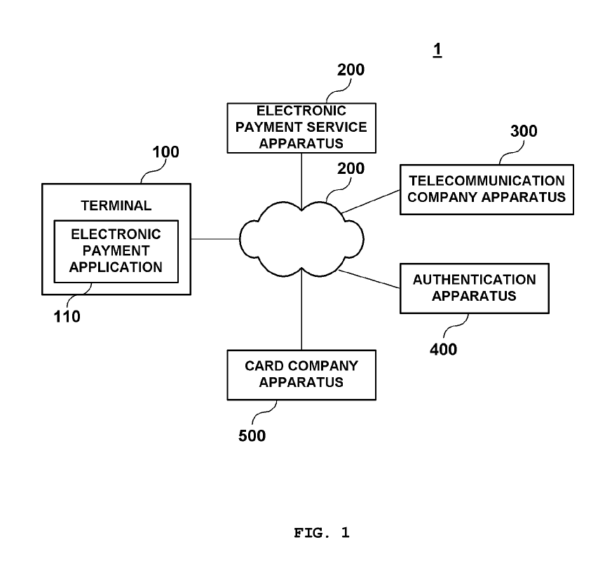

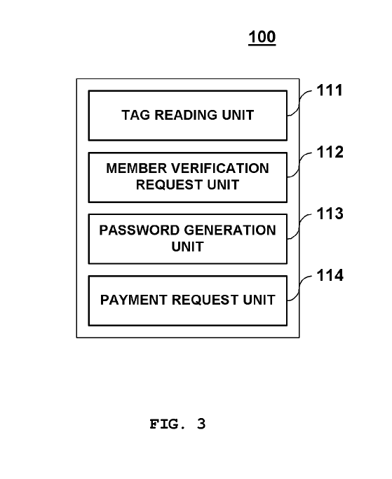

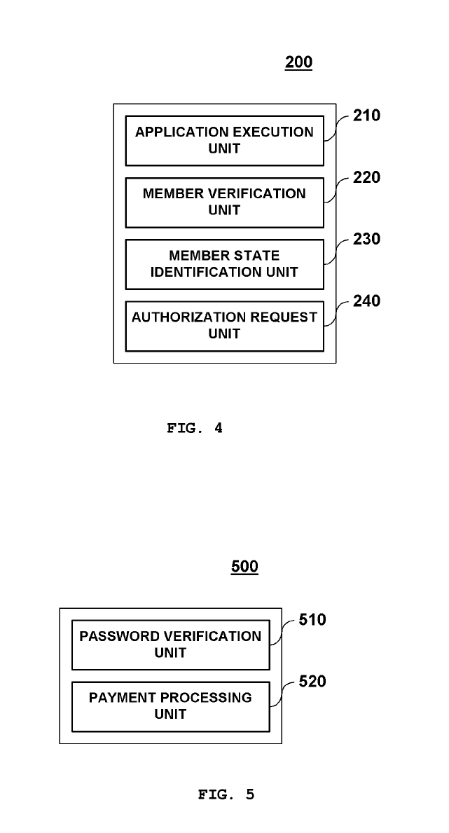

First, a payment system in accordance with another embodiment of the present invention will be described with reference to FIGS. 1 and 3 to 5. FIG. 1 is a block diagram schematically showing a payment system in accordance with a preferred embodiment of the present invention. FIG. 3 is a functional block diagram of a terminal of FIG. 1. FIG. 4 is a functional block diagram of an electronic payment service apparatus of FIG. 1. FIG. 5 is a functional block diagram of a card company apparatus of FIG. 1.

Referring to FIG. 1, a payment system 1 may comprise a terminal 100, an electronic payment service apparatus 200, a telecommunication company apparatus 300, an authentication apparatus 400, and a card company apparatus 500, which are connected through a communication network 700. Here, the operating bodies of the electronic payment service apparatus 200, the telecommunication company apparatus 300, the authentication apparatus 400, and the card company apparatus 500 may be different or the same.

The terminal 100 refers to a terminal that can transmit and receive various data via the communication network 700 in response to a user's key manipulation and may be any one of a tablet PC, a laptop, a personal computer (PC), a smart phone, a personal digital assistant (PDA), and a mobile communication terminal. Moreover, the terminal 100 may be a cloud computing terminal supporting cloud computing which provides services such as reading, writing, and storing of data, networking, use of content, etc. through the communication network 700.

That is, the terminal 100 performs a voice or data communication using the communication network 700 and refers to a terminal equipped with a browser for communication with the electronic payment service apparatus 200 via the communication network 700, a memory for storing programs and protocols, a microprocessor for calculation and control by executing various programs, etc. That is, any terminal is available as long as it provides server-client communication with the electronic payment service apparatus 200 and is a broad concept that encompasses all communication computing devices such as a notebook computer, a mobile communication terminal, a PDA, etc. Meanwhile, the terminal 100 may preferably be provided with a touch screen, but not necessarily limited thereto. It is described that the terminal 100 is implemented separately from the electronic payment service apparatus 200 in this embodiment, but the terminal 100 may be implemented as a standalone device that includes the electronic payment service apparatus 200 in an actual implementation of the invention.

An electronic payment application 110 may be installed in the terminal 100. The electronic payment application 110 may be obtained from the electronic payment service apparatus 200 during registration as a member of an electronic payment service which is provided by the electronic payment service apparatus 200. When the terminal 100 is a smart phone, the electronic payment application may be an application downloaded and installed from an application store, whereas when the terminal 100 is a feature phone, it may be an application executed by a virtual machine (VM) downloaded through the telecommunication company apparatus 300. The electronic payment application 110 may be implemented or designed to meet various operating system (OS) environments such as iOS, Android, Window Phone 7, etc. Specific operations of the electronic payment application 110 will be described later.

The electronic payment service apparatus 200 has the same configuration as a typical web server or network server. However, in a software configuration, the electronic payment service apparatus 200 includes a program module implemented using languages such as C, C++, Java, Visual Basic, Visual C, etc. The electronic payment service apparatus 200 may be implemented in the form of a web server or network server, and the web server refers to a computer system, which is connected to an unspecified number of clients and/or other servers through an open computer network such as the Internet, receives an operation execution request from a client or another web server, and provides the corresponding operation result, and a computer software (web server program) installed for the same. However, it should be understood that the electronic payment service apparatus 200 is a broad concept that encompasses a series of application programs executed on the web server and various databases built therein according to circumstances, in addition to the above-mentioned web server program. The electronic payment service apparatus 200 may be implemented on a typical server hardware using various web server programs provided for various operating systems such as DOS, Windows, Linux, UNIX, Macintosh, etc. Representative examples thereof may include Website, Internet Information Server (IIS), etc. used in Window environment and CERN, NCSA, APPACH, etc. used in UNIX environment.

Moreover, the electronic payment service apparatus 200 classifies member subscription information and stores and manages the information in a member database, which may be implemented inside or outside the electronic payment service apparatus 200. Such a database refers to a typical data structure implemented in a storage space (e.g., a hard disk or memory) of a computer system using a database management system (DBMS), in which retrieval (extraction), deletion, edition, addition, etc. of data can be freely performed. The database may be implemented to achieve the purpose of this embodiment using a relational database management system (RDBMS) such as Oracle, Infomix, Sybase, DB2, etc., an object-oriented database management system (OODBMS) such as Gemston, Orion, O2, etc. or an XML native database such as Excelon, Tamino, Sekaiju, etc., and has appropriate fields or elements to achieve their functions.

The telecommunication company apparatus 300 may manage a telecommunication company member database and perform telecommunication company member authentication.

The authentication apparatus 400 may be a server operated by an authentication institution such as NICE and may perform authentication of members subscribed to the electronic payment service.

The card company apparatus 500 may be a server operated by a card company and may be an apparatus that performs the actual payment based on credit card information (e.g., a real card number).

The communication network 700 refers to a network that can transmit and receive data via the Internet protocol using various wired and wireless communication technologies such as the Internet network, Intranet network, mobile communication network, satellite communication network, etc. Moreover, the communication network 700 may comprise a cloud computing network which is connected to the electronic payment service apparatus 200 to store computing resources such as hardware, software, etc. and provide the computing resources required by a client to the corresponding terminal 100. Here, the cloud computing refers to a computing environment where information is permanently stored in a server on the Internet and temporarily stored in a client terminal such as a desktop, tablet, notebook, netbook, smart phone, etc., and the cloud computing network refers to a computer environment access network where all users' information is stored in a server on the Internet such that the information can be used anywhere and anytime through various IT devices.

The communication network 700 is a concept that generally refers to closed networks such as a local area network, wide area network (WAN), etc., open networks such as the Internet, etc., wireless communication networks such as code division multiple access (CDMA), wideband code division multiple access (WCDMA), global system for mobile communications (GSM), long term evolution (LTE), evolved packet core (EPC), etc., next-generation networks which will be implemented in the future, and cloud computing networks. The terminal 100 and the electronic payment service apparatus 200 do not store the actual credit card information, but only the card company apparatus 500 may store and manage the actual credit card information.

In this electronic payment system 1, the electronic payment service apparatus 200 may provide the electronic payment service in conjunction with the electronic payment application 110 installed in the terminal 100. When receiving an electronic payment request from the terminal 100, the electronic payment service apparatus 200 may transmit a request for execution of the electronic payment application 110 to the terminal 100. Moreover, the electronic payment service apparatus 200 may receive an application ID from the electronic payment application 110, perform member verification using the application ID, and transmit the member verification result to the electronic payment application 110. Then, when receiving a one-time password generated by the electronic payment application 110 from the electronic payment application 110, the electronic payment service apparatus 200 may mediate an electronic payment for a transaction that takes place offline using the received one-time password. Specific details regarding the electronic payment will be described later.

As shown in FIG. 3, the terminal 100 may comprise a tag reading unit 111, a member verification request unit 112, a password generation unit 113, and a payment request unit 114. The member verification request unit 112, the password generation unit 113, and the payment request unit 114 may be installed in the terminal 100 when the electronic payment application 110 is installed in the terminal 100.

The tag reading unit 111 may read (or scan) payment information from an electronic tag on which offline payment information is written. The electronic tag (e.g., RFID) may be an electronic tag of an affiliated store subscribed to the electronic payment service of the present invention. Otherwise, the electronic tag may be an electronic tag attached to each offline commodity. In this case, the user of the terminal 100 may read the electronic tag by bringing the terminal 100 with the tag reading unit 111 in an activated state into close contact with the electronic tag related to a selected menu, a selected movie poster, a selected game, or a selected commodity. By the reading of the electronic tag, commodity-related payment information such as affiliated store information, payment identification information, purchase price information, etc. can be read by the terminal 100. When reading the electronic tag, the tag reading unit 111 may transmit a payment request to the electronic payment service apparatus 200. Then, the tag reading unit 111 may receive a request for execution of an electronic payment application from the electronic payment service apparatus 200. When the tag reading unit 111 receives the request for the execution of the electronic payment application, a screen for guiding input of personal identification information, e.g., a personal identification number (PIN), may be displayed on the terminal 100. The personal identification information may be a number, a letter, a PIN, or a combination thereof. The personal identification information is a number registered when the user subscribes to the electronic payment service and may be managed on the terminal 100. When the user inputs his or her personal identification information, the electronic payment application 110 may be executed in the terminal 100. A URL for guiding access to the electronic payment service apparatus 200 and a command for automatically accessing the URL are included in the electronic tag, and when the tag reading unit 111 reads the command, the terminal 100 can automatically access the electronic payment service apparatus 200. Moreover, the electronic payment service apparatus 200 may transmit a request for execution of an electronic payment application to the terminal 100 in response to the attempt to access the electronic payment service apparatus 200 by the terminal 100. In response to the execution of the electronic payment application 110 in the terminal 100, the member verification request unit 112 may make a member verification request by transmitting an application ID to the electronic payment service apparatus 200. At this time, the member verification request unit 112 may transmit a phone number together with the application ID. Moreover, the member verification request unit 112 may receive the member verification result from the electronic payment service apparatus 200. The application ID may be unique information assigned to the electronic payment application during the subscription to the electronic payment service. The application ID may be used during the member verification.

When the member verification request unit 112 receives the member verification result that the user is a member, the password generation unit 113 may generate a one-time password. The one-time password is a one-time number generated for each electronic payment and may be generated by a known method. For example, the one-time password may be generated by an OTP method. To this end, the terminal 100 and the card company apparatus 500 may share an OTP authentication key (seed). The OTP authentication key used during the generation of the one-time password may be received from the card company apparatus 500 during the subscription to the electronic payment service. The OTP authentication key may be decrypted with the personal identification information.

The payment request unit 114 may make a payment authorization request by transmitting the one-time password generated by the password generation unit 113 and the payment information to the electronic payment service apparatus 200. The payment authorization result may be received from the electronic payment service apparatus 200. At this time, the payment authorization result may be displayed on the terminal 100.

As shown in FIG. 4, the electronic payment service apparatus 200 may comprise an application execution unit 210, a member verification unit 220, a member state identification unit 230, and an authorization request unit 240.

When receiving the payment request from the terminal 100 in response to the reading of the electronic tag by the tag reading unit 111, the application execution unit 210 may transmit a request for execution of an electronic payment application to the terminal 100.

The member verification unit 220 may receive an application ID from the member verification request unit 112 and perform member verification using the received application ID. At this time, the member verification unit 220 may receive a phone number of the terminal 100 or a resident registration number of the user at the same time. Moreover, the member verification unit 220 may determine whether the information matching the application ID and phone number of the terminal 100 or the resident registration number of the user is stored in the member database managed by the electronic payment service apparatus 200. As a result of the determination, when the application ID and phone number or the resident registration number received from the member verification request unit 112 is stored in the member database, it may be determined that the user of the corresponding terminal 100 has been subscribed to the electronic payment service. Moreover, the member verification unit 220 may transmit the member verification result to the member verification request unit 112.

When receiving the payment information and the one-time password from the payment request unit 114, the member state identification unit 230 may identify the telecommunication company member state. At this time, when the terminal 100 has been subscribed to a telecommunication company that is affiliated with the electronic payment service apparatus 200, the member state identification unit 230 may transmit a state identification request to the corresponding telecommunication company apparatus 300 and receive the state identification result from the telecommunication company apparatus 300. Otherwise, when the terminal 100 has been subscribed to a telecommunication company that is not affiliated with the electronic payment service apparatus 200, the member state identification unit 230 may transmit a state identification request to the authentication apparatus 400 and receive the state identification result. The telecommunication company member state identification may be performed to identify whether the electronic payment service member, who is requesting the transaction, coincides with the owner of the terminal. During the telecommunication company member state identification request, the member state identification unit 230 may transmit the real name, resident registration number, and phone number of the electronic payment service member to the telecommunication company apparatus 300 or the authentication apparatus 400 and identify whether the member has been subscribed to the corresponding telecommunication company using the real name, resident registration number, and phone number of the member.

As a result of the telecommunication company state identification, only when it is determined that the electronic payment service member is a communication company member, the authorization request unit 240 may transmit a payment authorization request to the card company apparatus 500. During the payment authorization request, the authorization request unit 240 may transmit a virtual card number, the payment information, and the one-time password. The virtual card number may be a number matching the credit card registered as a payment method or major payment method during the subscription to the electronic payment service. The electronic payment service apparatus 200 may manage only the virtual card number without keeping the real card number. That is, in the step of performing the electronic payment, the real card number can be used only by the card company apparatus 500. The authorization request unit 240 may receive the payment authorization result from the card company apparatus 500 and transmit the received result to the payment request unit 114. Otherwise, the authorization request unit 240 may transmit the payment authorization result to an affiliated store terminal (not shown) in which a tag scanned by the corresponding terminal is installed.

As shown in FIG. 5, the card company apparatus 500 may comprise a password verification unit 510 and a payment processing unit 520.

When receiving the payment authorization request from the authorization request unit 240, the password verification unit 510 may verify the one-time password received from the authorization request unit 240. In the case where the OTP method is used, the card company apparatus 500 may possess the same OTP authentication key as that provided to the terminal 100 during the subscription to the electronic payment service. Moreover, the password verification unit 510 may generate a one-time password using the OTP authentication key in the same manner as the terminal 100 and then verify the received one-time password using the generated one-time password.

When the password verification unit 510 verifies that the one-time password received from the authorization request unit 240 is valid, the payment processing unit 520 may perform payment authorization using the real card number mapped to the virtual card number. Moreover, the payment processing unit 520 may transmit the payment authorization result to the authorization request unit 240.

Next, a payment system in accordance with another embodiment of the present invention will be described. Repeated description of those described above will be omitted or simplified.

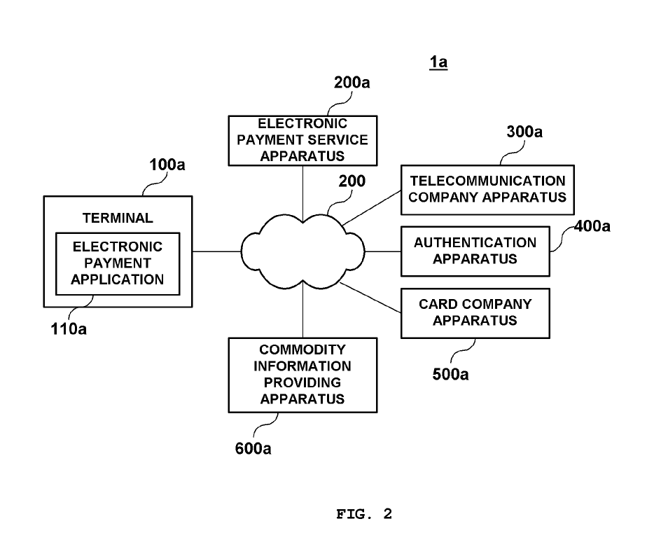

FIG. 2 is a block diagram schematically showing a payment system in accordance with another embodiment of the present invention.

Referring to FIG. 2, a payment system 1a in accordance with another embodiment of the present invention may comprise a terminal 100a, an electronic payment service apparatus 200a, a telecommunication company apparatus 300a, an authentication apparatus 400a, a card company apparatus 500a, and a commodity information providing apparatus 600a, which are connected through a communication network 700. The functions and operations of the electronic payment service apparatus 200a, the telecommunication company apparatus 300a, the authentication apparatus 400a, and the card company apparatus 500a may be the same as those in the payment system 1 in accordance with a preferred embodiment of the present invention. That is, the terminal 100a, the electronic payment service apparatus 200a, and the card company apparatus 500a may be configured as shown in FIGS. 3 to 5 and may be partially different in their operations.

Here, the operating bodies of the electronic payment service apparatus 200a, the telecommunication company apparatus 300a, the authentication apparatus 400a, the card company apparatus 500a, and the commodity information providing apparatus 600a may be different or the same. The commodity information providing apparatus 600a may store commodity information related to an electronic tag and provide the commodity information to the terminal 100a in response to a request from the terminal 100a.

In this electronic payment system 1a, the terminal 100a may request a commodity information-related page from the commodity information providing apparatus 600a in response to the reading of information on the electronic tag and transmit an electronic payment request to the electronic payment service apparatus 200a by selecting the electronic payment on the commodity information-related page received from the commodity information providing apparatus 600a. Moreover, the terminal 100a may receive a request for execution of an electronic payment application from the electronic payment service apparatus 200a and make a member verification request by transmitting an application ID to the electronic payment service apparatus 200a in response to the execution of the electronic payment application. Moreover, in response to the reception of the member verification result from the electronic payment service apparatus 200a, the terminal 100a may make a payment authorization request by transmitting a one-time password generated by an electronic payment application 110a to the electronic payment service apparatus 200a and receive the payment authorization result from the electronic payment service apparatus 200a. Differently from the above, the OTP authentication key may be provided by the service apparatus 200, 200a in the member subscription step. In this case, the payment system 1a may be implemented in a manner that the service apparatus 200, 200a verifies an OTP number generated by the terminal 100, 100a.

In another embodiment of the present invention, a tag reading unit 111 of the terminal 100a may read (or scan) payment information from an electronic tag on which offline payment information is written. The tag reading unit 111 may request a commodity information-related page associated with the electronic tag from the commodity information providing apparatus 600a using a community information URL written on the electronic tag and obtain the requested page from the commodity information providing apparatus 600a. When receiving the commodity information-related page, the tag reading unit 111 may display the received commodity information-related page on the terminal 100a. Therefore, a user can obtain detailed information about the commodity that the user wants to purchase. For example, when an electronic tag attached to a movie poster is clicked, a preview of the corresponding movie, a theater of the corresponding movie, remaining seats of the corresponding theater, etc. may be introduced. At this time, the user may purchase a commodity or make a reservation by a known method. At this time, the payment information related to the corresponding commodity may be provided from the commodity information providing apparatus 600a to the terminal 100a. Moreover, when the user selects an electronic payment, the tag reading unit 111 may transmit a payment request to the electronic payment service apparatus 200a. Furthermore, the tag reading unit 111 may receive a request for execution of an electronic payment application from the electronic payment service apparatus 200a. When the tag reading unit 111 receives the request for the execution of the electronic payment application, a screen for guiding input of personal identification information, e.g., a personal identification number (PIN), may be displayed on the terminal 100a. When the user inputs the personal identification information, the electronic payment application 110a may be executed in the terminal 100a. The functions and operations of the member verification request unit 112, the password generation unit 113, and the payment request unit 114 after the electronic payment application 110a is executed in the terminal 100a are the same as described above.

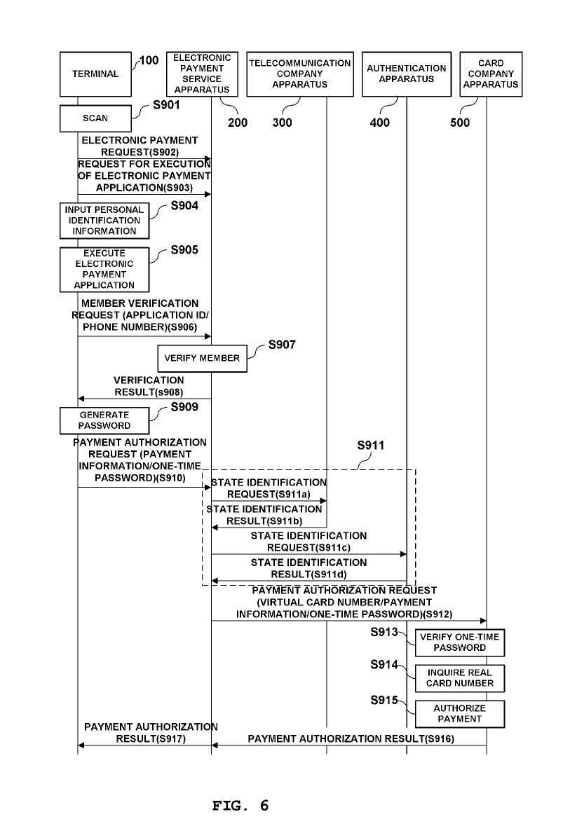

Next, an offline transaction payment method in accordance with a preferred embodiment of the present invention will be described with reference to FIGS. 1 and 3 to 6. FIG. 6 is a flowchart showing an offline transaction payment method in accordance with a preferred embodiment of the present invention. By the following description, the above-described payment system 1 in accordance with a preferred embodiment of the present invention will become more apparent. Repeated description of those described above will be omitted or simplified.

First of all, the terminal 100 may perform scanning (S901). At this time, the tag reading unit 111 in the terminal 100 may read (or scan) payment information from an electronic tag on which offline payment information is written.

Then, the terminal 100 may transmit an electronic payment request to the electronic payment service apparatus 200 (S902). The payment request may include a URL for guiding access to the electronic payment service apparatus 200 and a command for automatically accessing the URL and may be performed in a manner that the terminal 100 automatically accesses the electronic payment service apparatus 200 when the tag reading unit 111 reads the command.

Then, when receiving the payment request from the terminal 100 in response to the reading of the electronic tag by the tag reading unit 111, the application execution unit 210 may transmit a request for execution of an electronic payment application to the terminal 100 (S903).

Then, when the tag reading unit 111 receives the electronic payment application execution request, a screen for guiding input of personal identification information may be displayed on the terminal 100, and the personal identification information may be input by a user (S904).

Then, when the pre-registered personal identification information is put, the electronic payment application 110 may be executed in the terminal 100 (S905).

Then, in response to the execution of the electronic payment application 110 in the terminal 100, the member verification request unit 112 may make a member verification request by transmitting an application ID to the electronic payment service apparatus 200 (S906). At this time, the member verification request unit 112 may transmit a phone number together with the application ID.

Then, the member verification unit 220 which has received the application ID from the member verification request unit 112 may perform member verification using the received application ID (S907). At this time, the member verification unit 220 may receive a phone number of the terminal or a resident registration number of the user at the same time. Moreover, the member verification unit 220 may determine whether the information matching the application ID and phone number of the terminal or the resident registration number of the user is stored in the member database managed by the electronic payment service apparatus 200. As a result of the determination, when the application ID and phone number or the resident registration number received from the member verification request unit 112 is stored in the member database, it may be determined that the user of the corresponding terminal 100 has been subscribed to the electronic payment service.

Then, the member verification unit 220 may transmit the member verification result to the member verification request unit 112 (S908).

Then, when the member verification request unit 112 receives the member verification result that the user is a member, the password generation unit 113 may generate a one-time password (S909).

Then, the payment request unit 114 may make a payment authorization request by transmitting the one-time password generated by the password generation unit 113 and the payment information to the electronic payment service apparatus 200 (S910).

Then, when receiving the payment information and the one-time password from the payment request unit 114, the member state identification unit 230 may identify the telecommunication company member state (S911). At this time, when the terminal 100 has been subscribed to a telecommunication company that is affiliated with the electronic payment service apparatus 200, the member state identification unit 230 may transmit a state identification request to the corresponding telecommunication company apparatus 300 and receive the state identification result from the telecommunication company apparatus 300 (S911a, S911b). Otherwise, when the terminal 100 has been subscribed to a telecommunication company that is not affiliated with the electronic payment service apparatus 200, the member state identification unit 230 may transmit a state identification request to the authentication apparatus 400 and receive the state identification result (S911c, S911d).

Then, as a result of the telecommunication company state identification, only when it is determined that the electronic payment service member is a communication company member, the authorization request unit 240 may transmit a payment authorization request to the card company apparatus 500 (S912). During the payment authorization request, the authorization request unit 240 may transmit a virtual card number, the payment information, and the one-time password.

Then, when receiving the payment authorization request from the authorization request unit 240, the password verification unit 510 may verify the one-time password received from the authorization request unit 240 (S913).

When the password verification unit 510 verifies that the one-time password received from the authorization request unit 240 is valid, the payment processing unit 520 may inquire the real card number mapped to the virtual card number (S914).

Then, the password processing unit 520 may perform payment authorization using the inquired real card number (S915).

Then, the payment processing unit 520 may transmit the payment authorization result to the authorization request unit 240 (S916).

The authorization request unit 240 which has received the payment authorization result may receive the payment authorization result from the card company apparatus 500 and transmit the received result to the payment request unit 114 (S917). Otherwise, the authorization request unit 240 may transmit the payment authorization result to an affiliated store terminal in which a tag scanned by the corresponding terminal is installed.

The process of FIG. 4 may be fully or partially implemented. For example, the step of identifying the telecommunication company member state (S911) may be omitted. Otherwise, when the terminal 100 reads the electronic tag, the process may be implemented in a manner that the terminal 100 autonomously guides the user to input the personal identification information and, when the personal identification information is input by the user, the electronic payment application is executed and, at the same time, the member verification is requested. In this case, steps S902 and S903 may be omitted.

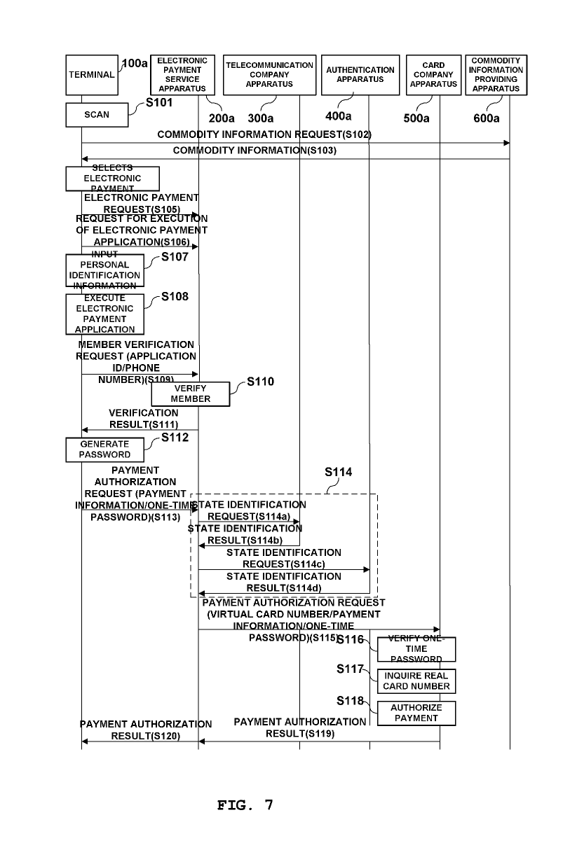

Next, an offline transaction payment method in accordance with another embodiment of the present invention will be described with reference to FIGS. 2 to 7. FIG. 7 is a flowchart showing an offline transaction payment method in accordance with another embodiment of the present invention. By the following description, the above-described payment system 1a in accordance with another embodiment of the present invention will become more apparent. Repeated description of those described above will be omitted or simplified.

First of all, the terminal 100a may perform scanning (S101).

Then, the terminal 100a may request a commodity information-related page from the commodity information providing apparatus 600a in response to the reading of information on an electronic tag and receive the same (S102, S103).

Then, when a user selects an electronic payment from the commodity information-related page (S104), the terminal 100a may transmit an electronic payment request to the electronic payment service apparatus 200a (S105).

Then, when receiving the payment request from the terminal 100a, the application execution unit 210 may transmit a request for execution of an electronic payment application, to the terminal 100a (S106).

Then, when the tag reading unit 111 receives the request for the execution of the electronic payment application, a screen for guiding input of personal identification information may be displayed on the terminal 100a, and the personal identification information may be input by the user (S107).

Then, when the pre-registered personal identification information is put, the electronic payment application 110a may be executed in the terminal 100a (S108).

Then, in response to the execution of the electronic payment application 110a in the terminal 100a, the member verification request unit 112 may make a member verification request by transmitting an application ID to the electronic payment service apparatus 200a (S109). At this time, the member verification request unit 112 may transmit a phone number together with the application ID.

Then, the member verification unit 220 which has received the application ID from the member verification request unit 112 may perform member verification using the received application ID (S110). At this time, the member verification unit 220 may receive a phone number of the terminal 100a or a resident registration number of the user at the same time. Moreover, the member verification unit 220 may determine whether the information matching the application ID and phone number of the terminal 100a or the resident registration number of the user is stored in the member database managed by the electronic payment service apparatus 200a. As a result of the determination, when the application ID and phone number or the resident registration number received from the member verification request unit 112 is stored in the member database, it may be determined that the user of the corresponding terminal 100a has been subscribed to the electronic payment service.

Then, the member verification unit 220 may transmit the member verification result to the member verification request unit 112 (S111).

Then, when the member verification request unit 112 receives the member verification result that the user is a member, the password generation unit 113 may generate a one-time password (S112).

Then, the payment request unit 114 may make a payment authorization request by transmitting the one-time password generated by the password generation unit 113 and the payment information to the electronic payment service apparatus 200a (S113).

Then, when receiving the payment information and the one-time password from the payment request unit 114, the member state identification unit 230 may identify the telecommunication company member state (S114). At this time, when the terminal 100a has been subscribed to a telecommunication company that is affiliated with the electronic payment service apparatus 200a, the member state identification unit 230 may transmit a state identification request to the corresponding telecommunication company apparatus 300a and receive the state identification result from the telecommunication company apparatus 300a (S114a, S114b). Otherwise, when the terminal 100a has been subscribed to a telecommunication company that is not affiliated with the electronic payment service apparatus 200a, the member state identification unit 230 may transmit a state identification request to the authentication apparatus 400a and receive the state identification result (S114c, S114d).

Then, as a result of the telecommunication company state identification, only when it is determined that the electronic payment service member is a communication company member, the authorization request unit 240 may transmit a payment authorization request to the card company apparatus 500a (S115). During the payment authorization request, the authorization request unit 240 may transmit a virtual card number, the payment information, and the one-time password.

Then, when receiving the payment authorization request from the authorization request unit 240, the password verification unit 510 may verify the one-time password received from the authorization request unit 240 (S116).

When the password verification unit 510 verifies that the one-time password received from the authorization request unit 240 is valid, the payment processing unit 520 may inquire the real card number mapped to the virtual card number (S117).

Then, the password processing unit 520 may perform payment authorization using the inquired real card number (S118).

Then, the payment processing unit 520 may transmit the payment authorization result to the authorization request unit 240 (S119).

The authorization request unit 240 which has received the payment authorization result may receive the payment authorization result from the card company apparatus 500a and transmit the received result to the payment request unit 114 (S120). Otherwise, the authorization request unit 240 may transmit the payment authorization result to an affiliated store terminal in which a tag scanned by the corresponding terminal is installed.

The process of FIG. 7 may be fully or partially implemented. For example, the step of identifying the telecommunication company member state (S114) may be omitted. Otherwise, when the user selects the electronic payment, the process may be implemented in a manner that the terminal 100a autonomously guides the user to input the personal identification information and, when the personal identification information is input by the user, the electronic payment application is executed and, at the same time, the member verification is requested. In this case, steps S105 and S106 may be omitted. Moreover, differently from the above, when the OTP authentication is provided by the service apparatus 200, 200a in the member subscription step, the payment method may be implemented in a manner that the payment authorization request is made by the card company apparatus 500, 500a.

The offline transaction payment method according to the present invention may be implemented in the form of software that can be executed by various computer means and recorded on a computer-readable medium. Here, the computer-readable medium may include program commands, data files, data structures or a combination thereof. Program instructions recorded on the medium may be particularly designed and structured for the present invention or available to those skilled in computer software. Examples of the computer-readable recording medium include hardware devices, particularly configured to store and perform program commands, including magnetic media such as a hard disk, a floppy disk, and a magnetic tape; optical media such as a compact disk-read only memory (CD-ROM) and a digital versatile disc (DVD); magneto-optical media such as floptical disks; a read-only memory (ROM); a random access memory (RAM); and a flash memory. Program commands may include, for example, a high-level language code that can be executed by a computer using an interpreter, as well as a machine language code made by a complier. The hardware devices may be configured to be operated by one or more software modules to implement the present disclosure, and vice versa.

The above embodiments of the present invention described in the specification and drawings are illustrative only and are not intended to limit the scope of the invention in any way. It will be apparent to those skilled in the art to which the invention pertains that variations and modifications of the various embodiments described herein may be made without departing from the spirit and scope of the invention.

### INDUSTRIAL APPLICABILITY

The present invention relates to an offline transaction payment system and a method and apparatus for the same and, more particularly, to an offline transaction payment system and a method and apparatus for the same, which uses a one-time password (OTP).

According to the present invention, it is possible to safely make a payment for a transaction that takes place offline without having a credit card by registering the credit card to be used for an offline payment to subscribe to an electronic payment service and making an online payment for the offline transaction using a one-time password.

As described above, the present invention is applicable in the electronic payment field using credit card information to more safely make an electronic payment for the offline transaction, thus contributing to the development of the service industry.

1. A payment system comprising:
a terminal which transmits an electronic payment request to an electronic payment service apparatus by reading information of an electronic tag, receives a request for execution of an electronic payment application from the electronic payment service apparatus, the electronic payment application being executed when personal identification information is input, makes a member verification request by transmitting an application ID to the electronic payment service apparatus, receives the member verification result from the electronic payment service apparatus, makes a payment authorization request by transmitting a one-time password to the electronic payment service apparatus, and receives the payment authorization result from the electronic payment service apparatus; and
the electronic payment service apparatus which receives an electronic payment request from the terminal, transmits a request for execution of an electronic payment application to the terminal, receives an application ID from the electronic payment application executed in the terminal, performs member verification using the received application ID, transmits the member verification result to the electronic payment application, receives a one-time password from the electronic payment application, and mediates an electronic payment for a transaction that takes place offline using the one-time password.

2. An electronic payment service apparatus comprising:
an application execution unit which receives an electronic payment request from a terminal and transmits a request for execution of an electronic payment application to the terminal;
a member verification unit which receives an application ID from the electronic payment application executed in the terminal, performs member verification using the received application ID, and transmits the member verification result to the electronic payment application; and
an authorization request unit which receives a one-time password from the electronic payment application and mediates an electronic payment for a transaction that takes place offline using the one-time password.

3. The electronic payment service apparatus of claim 2, wherein the member verification is performed by determining whether the application ID received from the terminal and a phone number matching the application ID or a resident registration number is pre-stored.

4. The electronic payment service apparatus of claim 2, wherein the authorization request unit receives payment information and a one-time password from the terminal, transmits a payment authorization request including a virtual card number matching the terminal, the payment information, and the one-time password to a card company apparatus, and transmits the payment authorization result received from the card company apparatus to the terminal or an affiliated store terminal.

5. The electronic payment service apparatus of claim 2, wherein the virtual card number is generated in response to a card number registered as a payment means during member subscription and is information matching at least one of the phone number of the terminal, the application ID, and the resident registration number and managed.

6. The electronic payment service apparatus of claim 2, further comprising a member state identification unit which identifies a telecommunication company member state through an affiliated telecommunication company apparatus or an authentication apparatus, in response to the reception of the one-time password.

7. A terminal comprising:
a tag reading unit which transmits an electronic payment request to an electronic payment service apparatus by reading information of an electronic tag and receives a request for execution of an electronic payment application from the electronic payment service apparatus;
a member verification request unit which makes a member verification request by transmitting an application ID to the electronic payment service apparatus and receives the member verification result from the electronic payment service apparatus;
a password generation unit which generates a one-time password; and
a payment request unit which makes a payment authorization request by transmitting the one-time password to the electronic payment service apparatus and receives the payment authorization result from the electronic payment service apparatus.

8. The terminal of claim 7, wherein the electronic payment application is executed when a user inputs personal identification information registered during subscription to an electronic payment service.

9. The terminal of claim 7, wherein the application ID is unique information assigned to the electronic payment application during subscription to an electronic payment service.

10. The terminal of claim 7, wherein the electronic payment application generates the one-time password using an OTP authentication key received from a card company apparatus or the electronic payment service apparatus.

11. The terminal of claim 10, wherein the OTP authentication key is decrypted with the application ID.

12. A payment service providing method which is performed by an electronic payment service apparatus, the method comprising the steps of:
receiving an electronic payment request from a terminal;
transmitting a request for execution of an electronic payment application from the terminal;
receiving an application ID from the electronic payment application of the terminal;
performing member verification using the received application ID and transmitting the member verification result to the electronic payment application;
receiving a one-time password from the electronic payment application; and
mediating an electronic payment for a transaction that takes place offline using the one-time password.

13. A payment service providing method which is performed by a terminal, the method comprising the steps of:
transmitting an electronic payment request to an electronic payment service apparatus by reading information of an electronic tag;
receiving a request for execution of an electronic payment application from the electronic payment service apparatus;
making a member verification request by transmitting an application ID to the electronic payment service apparatus;
receiving the member verification result from the electronic payment service apparatus;
making a payment authorization request by transmitting a one-time password to the electronic payment service apparatus; and
receiving the payment authorization result from the electronic payment service apparatus.

14. A payment service providing method comprising the steps of:
transmitting, at a terminal, an electronic payment request to an electronic payment service apparatus by reading information of an electronic tag;
transmitting, at the electronic payment service apparatus, a request for execution of an electronic payment application to the electronic payment service apparatus when receiving the electronic payment request;
allowing the electronic payment application to be executed in the terminal;
making, at the terminal, a member verification request by transmitting an application ID to the electronic payment service apparatus;
performing, at the electronic payment service apparatus, member verification using the application ID and transmitting the member verification result to the terminal;
making, at the terminal, a payment authorization request by transmitting a one-time password to the electronic payment service apparatus; and
mediating, at the electronic payment service apparatus, an electronic payment for a transaction that takes place offline using the one-time password.
